(19) United States
(12) Patent Application Publication
(10) Pub. No.: US 2013/0022708 A1
(43) Pub. Date: Jan. 24, 2013

(54) GUM BASES HAVING REDUCED POLARITY AND CHEWING GUMS BASED THEREUPON

(71) Applicants: Xiaohu Xia, Evanston, IL (US); Steven P. Synosky, Green Brook, NJ (US); Michael S. Haas, Naperville, IL (US)

(72) Inventors: Xiaohu Xia, Evanston, IL (US); Steven P. Synosky, Green Brook, NJ (US); Michael S. Haas, Naperville, IL (US)

(21) Appl. No.: 13/521,089

(22) PCT Filed: Feb. 25, 2011
(86) PCT No.: PCT/US11/26173

§ 371 Date: Sep. 4, 2012

Related U.S. Application Data
(60) Provisional application No. 61/308,544, filed on Feb. 26, 2010.
(60) Provisional application No. 61/325,529, filed on Apr. 19, 2010.

(51) Int. Cl. A23G 4/08

(52) U.S. Cl. 426/4

(57) ABSTRACT

A gum base, which when formulated into a chewing gum provides a gum cud removable from concrete and cement surfaces, contains 3 to 30 wt. % elastomer, 0 to 32 wt. % elastomer solvent and 0 to 8% paraffin wax and has a polarity index of less than 2.00 MPa½ and chewing gums containing the gum base.

### CROSS-REFERENCE TO RELATED APPLICATIONS

This application claims benefit to U.S. Provisional Application No. 61/308,544 filed Feb. 26, 2010 and U.S. Provisional Application No. 61/325,529 filed Apr. 19, 2010, incorporated by reference herein.

### BACKGROUND OF THE INVENTION

The present invention relates to gum bases and chewing gums. More specifically, this invention relates to improved chewing gum bases and chewing gums with enhanced removability.

The precursors to today's chewing gum compositions were developed in the nineteenth century. Today's version is enjoyed daily by millions of people worldwide.

When chewing gum is chewed, water soluble components, such as sugars and sugar alcohols are released with varying degrees of speed within the mouth, leaving a water insoluble chewing gum cud. After some amount of time, typically after the majority of the water soluble components have been released therefrom, the cud may be disposed of by the user. Although typically not problematic when disposed of properly, e.g., when wrapped in a substrate such as the original wrapper and disposed of in a proper receptacle, improper disposal of chewing gum cuds can result in adhesion of cuds to environmental surfaces. Of particular concern to the public is the adhesion of such cuds to concrete and cement surfaces such as sidewalks, walls and flooring.

Concrete is a construction material composed of cement (commonly Portland cement) as well as other materials such as fly ash and slag cement, aggregate (generally a coarse aggregate such as gravel, limestone, or granite, plus a fine aggregate such as sand), water, and chemical admixtures. When finished and cured, it forms a rough, porous, hydrophilic surface.

Conventional gum bases used in commercial chewing gum products behave as viscous liquids which provide flow and elasticity characteristics which contribute to their desirable chewing properties. However, when the chewed cuds formed from such conventional chewing gum products become undesirably adhered to rough environmental surfaces such as concrete, over time, the elastomeric components flow into the pores, cracks and crevices of such surfaces. Furthermore, some of the components of gum base have significant chemical affinity for the polar surface of concrete. The problem is exacerbated when the adhered cud has been subjected to pressure (for example through foot traffic) and temperature cycling. If not removed promptly, adhered gum cuds can be extremely difficult or impossible to remove completely from concrete surfaces.

Past efforts directed to reducing the problem of gum cud adhesion have often been directed to retaining water in the cud or altering its texture by making it more cohesive or harder. While such formulations may reduce cud adhesion, they also can result in undesirable effects such as reducing consumer acceptance of the product (due to altered texture or flavor) or requiring expensive, hard to obtain or regulatorily unapproved ingredients. Thus there is a need for a gum base and chewing gum containing the same that exhibits the desired chewing and taste characteristics for consumer acceptability, has affordable manufacturing costs, and which also produces a cud which is easily removable from concrete and cement surfaces onto which it may have become adhered.

### SUMMARY OF THE INVENTION

A gum base, which when formulated into a chewing gum provides a gum cud removable from concrete and cement surfaces, contains 3 to 30 wt. % elastomer, 0 to 32 wt. % elastomer solvent and 0 to 8% paraffin wax and has a polarity index of less than 2.00 MPa^{½} and chewing gums containing the gum base.

### DESCRIPTION OF THE DRAWINGS

These and other features, aspects and advantages of the present invention will become better understood when the following detailed description is read with reference to the accompanying drawings wherein:

FIG. 1 shows removability test results for Examples/Comparative Runs 9-15.

FIG. 2 shows removability test results for Examples/Comparative Runs 17-23.

FIG. 3 shows removability test results for Examples/Comparative Runs 24-30.

### DESCRIPTION OF THE INVENTION

The invention is directed to gum bases and chewing gums in which the gum base components exhibit an overall polarity such that adhesion to environmental surfaces having polar chemical constituents such as concrete is reduced. For purposes of this invention, the term ‘gum base’ refers to all water insoluble components of a chewing gum (other than flavoring agents) which are present in a finished chewing gum, regardless of whether they are added as a separate, premixed composition or added individually to a chewing gum mixture. In some embodiments, the gum base will have a polarity index of less than 2.00 MPa^{½}. In some embodiments, the gum base will have a polarity index of less than 1.90 MPa^{½}. In some embodiments, the gum base will have a polarity index of less than 1.80 MPa^{½}. In some embodiments, the gum base will have a polarity index of less than 1.70 MPa¹″². In still other embodiments, the gum base will have a polarity index of less than 1.60 MPa^{½}.

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not intended to limit what is being described to any one position or spatial orientation.

If ranges are disclosed, the endpoints of all ranges directed to the same component or property are inclusive and independently combinable (e.g., ranges of “up to about 25 wt %, or, more specifically, about 5 wt % to about 20 wt %,” is inclusive of the endpoints and all intermediate values of the ranges of “about 5 wt % to about 25 wt %,” etc.). The modifier “about” used in connection with a quantity is inclusive of the stated value and has the meaning dictated by the context (e.g., includes the degree of error associated with measurement of the particular quantity). Further, unless otherwise stated, percents listed herein are weight percents (wt %) and are based upon the total weight of the gum base or chewing gum, as the case may be.

Concrete and cement typically have a rough surface and contain polar chemical surface constituents. Prior art gum bases typically have a high polarity (i.e. greater than about 2.00 MPa^{½}) which causes them to have significant affinity for the polar surface of concrete and cement. More specifically, this affinity is believed to be primarily due to a dipole-dipole interaction between the cud and the concrete which is believed to be in the range of 0.1 to 20 KJ/mole, depending upon the exact polarity of the cud and the concrete substrate.

In order to maintain satisfactory sensory (i.e. chewing texture and flavor release) properties, it is important that the gum base have an elastomer content of at least 3 wt. %. In some embodiments, the gum base will have an elastomer content of at least 5 wt. % or at least 10 wt. %. On the other hand, it is also important that the gum base contain less than 30 wt. % or even less than 25 wt. % elastomer to avoid excessive toughness and cohesion during chewing. Furthermore, in order to maintain satisfactory chewing properties, the gum base will have a paraffin wax content of less than 8 wt. % or less than 5 wt. % or even less than 2 wt. %. In some embodiments, the base will be free of paraffin wax.

In order to minimize adhesion to environmental surfaces, it is also important that the gum base contain less than 32% elastomer solvent. In some embodiments, the gum base will contain less than 30 wt. % or less than 25 wt. % elastomer solvent. In some embodiments, the gum base will be free of elastomer solvent. In order to help minimize the polarity of the gum base, it is desirable that the gum base contain less than 30 wt. % filler and less than 30 wt. % polyvinyl acetate. In some embodiments, the gum base will be free of filler and/or polyvinyl acetate. In some embodiments, high levels (such as at least 3 wt. % or at least 5 wt. % or at least 10 wt. % or even at least 15 wt. % of the gum base) of one or more emulsifiers such as lecithin or mono and di-glycerides may be employed to reduce adhesion to environmental surfaces. Other components of the gum base may be selected freely from common gum base ingredients (or less common substitutes therefor). In all cases however, the use of gum base components will be restricted by their contribution to the overall polarity index of the gum base as limited above.

The overall polarity of a gum base can be calculated as the sum of the polarity indexes of the individual components multiplied by their concentration in the gum base. The polarity index, δp, of the individual components can be calculated according to the formula:

δp=(ΣFp²)^{½}/Mw

where Fp is the polar group's molar attraction contribution and Mw is the molecular weight of the molecule. This formula is taken from Handbook of Solubility Parameters and Other Cohesion Parameters, second edition by Allan F. M. Barton, 1991 CRC Press, page 182-185. The reference also provides Fp values (from Beerbower) having the unit J^{1/2}cm^{3/2}mol⁻¹ for various chemical groups, some of which are listed in Table 1 along with Fp² values for ease of calculation.

TABLE 1

| Group | Fp (J^{1/2}cm^{3/2}mol⁻¹) | Fp² (Jcm³mol⁻²) |
|---|---|---|
| (—CH₃) | 0 | 0 |
| (—CH₂—) | 0 | 0 |
| (>CH—) | 0 | 0 |
| (>C<) | 0 | 0 |
| (═CH₂) | 94 | 8,836 |
| (═CH—) | 70 | 4,900 |
| (═C<) | 70 | 4,900 |
| (—COO—) | 511 | 261,121 |
| (>C═O) | 769 | 591,361 |
| (—COOH) | 419 | 175,561 |
| (—O—) | 401 | 160,801 |
| (—OH) | 499 | 249,001 |
| (>SiO<) | 307 | 94,249 |
| (-Phenyl) | 121 | 14,641 |
| (—PO₄) | 1890 | 3,572,100 |

Thus the polarity index for a gum base component may be calculated by adding the Fp² values for each of the chemical groups present in the molecule, taking the square root of that value, and dividing by the molecular weight. For example, the polarity index of polyvinylacetate can be calculated by adding the Fp² for the four groups making up the monomer units of the polymer, —CH₃, —CH₂, —CH< and —COO— which are 0, 0, 0 and 261,121 respectively for a total of 261,121. The square root of 261,121 is 511 and dividing by the molecular weight of the monomer unit (86) gives a polarity index of 5.94 MPa^{½}.

The Polarity Indices (PI) for common gum base ingredients are presented in Table 2.

TABLE 2

| | | Polarity |
|---|---|---|
| | | Index |
| Ingredient | Common Function | (MPa^{1/2}) |
| Polyisoprene | Elastomer | 1.46 |
| Styrene Butadiene Rubber | Elastomer | 1.66¹ |
| Butyl Rubber | Elastomer | 0 |
| Polyisobutylene | Elastomer | 0 |
| Natural Gum | Elastomer/Elastomer | 1.12² |
| | Solvent | |
| Triacetin | Plasticizer | 0³ |
| Acetylated Monoglycerides | Softener/Emulsifier | 3.11⁴ |
| Mono/diglycerides | Softener/Emulsifier | 2.19⁵ |
| Lecithin | Softener/Emulsifier | 3.07 |
| Hydrogenated Veg. Oil | Softener | 1.05⁶ |
| Paraffin Wax | Softener | 0 |
| Microcrystalline Wax | Softener | 0 |
| Polyethylene | Softener | 0 |
| Terpene Resin | Elastomer Solvent | 0.51⁷ |
| Estergum | Elastomer Solvent | 0.97 |
| Polyvinyl Acetate | Plastic Resin | 5.94 |
| Talc | Filler | 3.58 |
| Calcium Carbonate | Filler | 6.50 |
| Silica | Filler | 8.42 |
| Colors | Color | 0⁸ |
| Antioxidants | Antioxidant | 0⁸ |

¹Polarity Index is dependent on percent styrene in the polymer. Value given is for 25% styrene/75% butadiene, a common elastomer for chewing gum base
²Content of Natural gum is variable depending on the source. Value is for natural gum containing 30% polyisoprene, 70% natural rosin ester which is typical.
³Effective value of Triacetan is zero since it is extracted from the cud during chewing.
⁴Assumes 50% stearic and 50% palmitic acid as the monoglyceride.
⁵Assumes 75% glycerol monostearate and 25% glycerol distearate.
⁶Polarity Index of hydrogenated vegetable oil varies slightly depending on the fatty acid distribution. Value assumes triglycerides of 50% oleic acid and 50% palmitic acid which is typical of fat used in gum base.
⁷Value for polylimonene.
⁸Polarity contributions of color and antioxidant are negligible due to very low usage levels.

In general, the disclosed gum bases will contain conventional types of gum base ingredients such as elastomers, elastomer solvents, softeners, plastic resins (typically polyvinyl acetate), fillers, emulsifiers, colors and antioxidants. However, not all embodiments will include each of these types of ingredients.

Although the present gum bases are expected to exhibit enhanced removability from concrete, it is unlikely to formulate a gum base which exhibits no adhesion at all to concrete surfaces. Furthermore, reducing the polarity of the gum base is unlikely to have significant effect on the cud's adhesiveness to other, non-polar environmental surfaces. For these reasons, additional formulation efforts are desirable to further reduce adhesion to all surfaces. For example, reducing elastomer solvent levels to the greatest extent possible may improve removability. Also, in some embodiments, the gum bases may contain at least one removability enhancing component. The removability enhancing component may be an amphiphilic polymer, a low tack polymer, a polymer comprising hydrolysable units, an ester or ether of a polymer comprising hydrolysable units, crosslinked polymeric microparticles or combinations of these. These and other removability enhancing components may be premixed with a chewing gum base or added separately to a chewing gum mixture. In some embodiments an emulsifier, that may be encapsulated or spray dried, may be included in the chewing gum composition as a removability enhancing component.

The present invention provides gum bases and chewing gums which may render a gum cud containing the gum base more easily removable from concrete and cement surfaces to which it may have become adhered than gum cuds produced by conventional gum bases. Advantageously, the present gum bases also have chew properties consistent with those of conventional gum bases. That is, a gum base having low polarity indices and containing no more than the specified maximum levels of paraffin wax, elastomer and elastomer solvent forms a cud with is elastic yet deformable, readily recombines if torn apart, retains cohesion during the chewing process and forms a discrete gum cud. It will also have flavor retention/release properties similar to those of conventional gum gases. As a result, a chewing gum containing the gum base is expected to enjoy a high consumer-acceptability.

In order to further enhance the removability of cuds formed from chewing gums containing the gum bases described herein, it may be desirable to incorporate other known removability-enhancing features into the gum base and/or chewing gum.

For example, certain additives such as emulsifiers and amphiphilic polymers may be added. Another additive which may prove useful is a polymer having a straight or branched chain carbon-carbon polymer backbone and a multiplicity of side chains attached to the backbone as disclosed in WO 06-016179 hereby incorporated by reference herein in its entirety for any and all purposes, to the extent that it is not contradictory to the teachings provided herein. Still another additive which may enhance removability is a polymer containing hydrolyzable units or an ester and/or ether of such a polymer. One such polymer containing hydrolyzable units is a copolymer sold under the Trade name Gantrez®. Addition of one or more such polymers at levels of from about 1 wt % to about 20 wt % based upon the total weight of the chewing gum base may reduce adhesion of discarded gum cuds.

Within the limits expressed herein, the gum bases made according to this disclosure may be formulated with conventional gum base ingredients at levels normally used for their purpose. Thus, a typical gum base made according to this disclosure will typically contain one or more elastomers, elastomer solvents, softeners, plastic resins, fillers, colors, antioxidants and emulsifiers as well as other conventional gum base components. Except as noted, there is no specific requirement to use any or all of these components or to use them at conventional levels as long as the resulting gum base is suitable for its purpose.

Common gum base elastomers include common linear hydrocarbon polymers such as butyl rubber, styrene-butadiene rubber, polyisobutylene, and polyisoprene (for example from natural gum), although other less conventional elastomers may also be employed. One such unconventional elastomer is crosslinked polymeric microparticles as disclosed in co-pending application 61/263462. Elastomers are essential to the composition of a gum base as they provide resilience or “bounce” to the gum cud. A minimum level of 3 wt. % is necessary for this purpose, with higher levels generally desirable. However, levels above 30 wt. % are to be avoided because they will make the chew excessively tough and cohesive and may increase adhesion of the cud to environmental surfaces. Where natural gums are used, it is important to remember that these contain both elastomer and elastomer solvent (ester gums), typically in a 30:70 ratio. This should be factored into calculations of elastomer and elastomer solvent levels in the final base composition. Natural gums include chicle, jelutong, lechi caspi perillo. massaranduba balata, massaranduba chocolate, nispero, rosidinha, gutta percha, gutta kataiu, niger gutta, tunu, chilte, chiquibul and gutta hang kang. It is also important that these polymers have sufficient molecular weight to act as elastomers. For the common linear hydrocarbon polymers listed above, the weight average molecular weight (M_{w}) must be at least 200,000 and preferably at least 400,000 daltons. Branched polymers may be effective elastomers at lower molecular weights. Polymers with insufficient molecular weight to act as elastomers may however be useful as texturizing agents or for other purposes.

In some embodiments, an elastomer solvent may be employed to improve elasticity and compatibility of the elastomer with other gum base components. Elastomer solvents commonly used for synthetic elastomers include but are not limited to, natural rosin esters, often called estergums, such as glycerol esters of partially hydrogenated rosin, glycerol esters of polymerized rosin, glycerol esters of partially or fully dimerized rosin, glycerol esters of rosin, pentaerythritol esters of partially hydrogenated rosin, methyl and partially hydrogenated methyl esters of rosin, pentaerythritol esters of rosin, glycerol esters of wood rosin, glycerol esters of gum rosin; synthetics such as terpene resins derived from alpha-pinene, beta-pinene, and/or d-limonene; and any suitable combinations of the foregoing. The preferred elastomer solvents also will vary depending on the specific application, and on the type of elastomer which is used. As previously mentioned, estergums (natural rosin esters) are also a component of natural gums which, when used, typically require less added elastomer solvent. Where used, elastomer solvents (including the estergum component of natural gums) may be present at levels of 1 to 32 wt. % of the gum base. Proper usage level will typically depend on the type and level of elastomer present as well as the desired chewing properties of the chewing gum product. However, higher levels of elastomer solvent are undesirable as they may result in increased adhesion of discarded cuds to environmental surfaces. Levels above 32 wt. % may also increase adhesion of the cud to teeth and dental work as well as lips skin and facial hair due to over-plasticization of the elastomer.

Softeners may be added to gum bases in order to optimize the chewability and mouth feel of a chewing gum based upon the same. Softeners typically are used include tallow, hydrogenated tallow, hydrogenated and partially hydrogenated vegetable oils, cocoa butter, glycerol triacetate, lecithin, microcrystalline wax, natural waxes and combinations thereof. Generally, the gum base will contain up to about 30 wt % or up to about 40 wt % softener, based upon the total weight of the gum base.

Paraffin wax may also be employed as a softener at levels up to 8 wt. %, or up to 5 wt. % or up to 2 wt. %. However, higher levels of paraffin wax are to be avoided due to its tendency to over-soften the gum base. Paraffin wax consists of unbranched C₂₀ to C₄₀ alkanes as opposed to the branched structure of the preferred microcrystalline wax. It is believed that the branching of the microcrystalline wax provides greater structure to the gum base even as it softens the cud. It should be noted that microcrystalline wax typically contains some level of unbranched alkanes. This can be disregarded for purposes of the present patent as the above formulation limitations have been determined empirically using the ingredients as they are commonly supplied by manufacturers.

It is sometimes desirable to add some or all of the softener to the gum mixer rather than incorporate it into the premixed gum base. In such cases it is important to include the filler added to the gum mixer in the polarity index calculations for the gum base.

Emulsifiers such as lecithin, mono- and di-glycerides and acetylated mono- and di-glycerides are often incorporated into the gum base and/or the chewing gum composition to improve compatibility of the various components. Emulsifiers also act as softeners for the gum base. Traditional chewing gums and gum bases often employ emulsifiers at levels up to 1 or 2% by weight of the respective composition. However, to improve cud removability, higher levels may be employed in the present invention. When used at higher levels (above 3 wt. %) it may be desirable to spray dry or encapsulate all or a portion of the emulsifier to prevent dissolution of the gum cud during chewing. Where used, emulsifiers may be added to the gum base, the chewing gum or both. No matter where they are added, they should be included in the polarity index calculation for the gum base.

The gum bases of the present invention may optionally include one or more plastic resins. Examples of plastic resins include polyvinyl acetate, vinyl acetate-vinyl laurate copolymer having vinyl laurate content of about 5 to about 50 percent by weight of the copolymer, and combinations thereof. Of these, polyvinyl acetate is a preferred plastic resin. Preferred weight average molecular weights (by GPC) for polyvinyl acetate are 2,000 to 90,000 or 10,000 to 65,000 (with higher molecular weight polyvinyl acetates typically used in bubble gum bases). For vinyl acetate-vinyl laurate, vinyl laurate content of from about 10 wt % to about 45 wt % of the copolymer is preferred. Where used, plastic resins preferably constitute 1 to 15 wt. % of the gum base composition. Higher levels (up to 30%) may be used if care is taken in formulation to ensure that the overall base polarity does not exceed the specified values. Polyvinyl acetate may help reduce adhesion of the cud to dental and environmental surfaces, as long as its usage level does not cause excessive polarity.

Fillers typically are inorganic, water-insoluble powders such as magnesium and calcium carbonate, ground limestone, silicate types such as magnesium and aluminum silicate, clay, alumina, talc, titanium oxide, mono-, di- and tri-calcium phosphate and calcium sulfate. Insoluble organic fillers including cellulose polymers such as wood as well as combinations of any of these also may be used. If used, fillers may typically be included in amounts from about 1 wt % to about 30 wt % filler, based upon the total weight of the gum base. However, due to the high polarity indices of the most common fillers, it is preferred that the filler level not exceed 15 wt. % or more preferably 10 wt. % of the gum base. It is sometimes desirable to add some or all of the filler to the gum mixer rather than incorporate it into the premixed gum base. In such cases it is important to include the filler added to the gum mixer in the polarity index calculations for the gum base. Because fillers are known to increase adhesion of the chewed cud to environmental surfaces, in some embodiments the total filler (including any filler added to the gum mixer) will be limited to 0 to 5% by weight of the gum base.

Colorants and whiteners may include FD&C-type dyes and lakes, fruit and vegetable extracts, titanium dioxide, and combinations thereof. Antioxidants such as BHA, BHT, tocopherols, propyl gallate and other food acceptable antioxidants may be employed to prevent oxidation of fats, oils and elastomers in the gum base. Such ingredients may be used at conventional levels in the present invention without significantly affecting the overall polarity of the gum base.

The gum base described herein may include wax or be wax-free. An example of a wax-free gum base is disclosed in U.S. Pat. No. 5,286,500, the disclosure of which is incorporated herein by reference to the extent that it is consistent with the teachings provided herein. It is preferred that the gum bases of the present invention be free of paraffin wax.

Generally, gum bases of the present invention will be a premix of the previously mentioned components which will be compounded prior to introduction into a chewing gum mixer. Such premixed gum bases can be produced using conventional gum base mixing techniques. In such processes, the elastomers are typically first ground or shredded along with at least a portion of any desired filler. Then the ground elastomer is transferred to a batch mixer for compounding. Any standard, commercially available mixer (e.g., a Sigma blade mixer) may be used for this purpose. Compounding typically involves combining the ground elastomer with filler and elastomer solvent and mixing until a homogeneous mixture is produced, typically for about 30 to about 70 minutes. Thereafter, any desired additional filler and elastomer solvent are added followed by softeners, while mixing to homogeneity after each addition. Minor ingredients such as antioxidants and color may be added at any time in the process.

Continuous processes using mixing extruders, which are generally known in the art, may also be used to prepare the gum base premix. In a typical continuous mixing process, initial ingredients including ground elastomer are metered continuously into extruder ports at various points along the length of the extruder corresponding to the batch processing sequence.

After the initial ingredients have mixed homogeneously and have been sufficiently compounded, the balance of the base ingredients are metered into ports or injected at various points along the length of the extruder. Typically, any remainder of elastomer component or other components are added after the initial compounding stage. The composition is then further processed to produce a homogeneous mass before discharging from the extruder outlet. Typically, the transit time through the extruder will be less than an hour.

Exemplary methods of continuous mixing include the following, the entire contents of each being incorporated herein by reference to the extent that they do not contradict the teachings herein: (i) U.S. Pat. No. 6,238,710, which describes a method for continuous chewing gum base manufacturing, which entails compounding all ingredients in a single extruder; (ii) U.S. Pat. No. 6,086,925 which discloses the manufacture of chewing gum base by adding a hard elastomer, a filler and a lubricating agent to a continuous mixer; (iii) U.S. Pat. No. 5,419,919 which discloses continuous gum base manufacture using a paddle mixer by selectively feeding different ingredients at different locations on the mixer; and, (iv) U.S. Pat. No. 5,397,580 which discloses continuous gum base manufacture wherein two continuous mixers are arranged in series and the blend from the first continuous mixer is continuously added to the second extruder.

The completed base may be extruded or cast into any desirable shape (e.g., balls, pellets, sheets or slabs) and allowed to cool and solidify. In some cases, it may be preferable to use an underwater pelletization process for this purpose.

In some cases, it may be desirable to add at least a portion of some of the gum base ingredients to the gum mixer during the gum mixing process as opposed to incorporating them into the premixed gum base.

Chewing gum bases of the present invention may be formulated to have good or even excellent chewing properties. By good or excellent chewing properties, it is meant that the cud will be enjoyable for consumers to chew because it is neither excessively soft nor excessively cohesive, neither excessively bouncy nor dead, not noisy or squeaky and smooth without being excessively slippery. Of course, personal preference of individual consumers will vary in regard to these properties. Formulators of ordinary skill in the art will be able to formulate gum bases within the limitations of the present invention which will satisfy the target consumer. As is always the case, the optimum formulation will be obtained by making first larger, then smaller adjustments to the formula while sensorically evaluating the effect. Rheological measurements can also be of assistance to the formulator. A typical gum base formulated according to the present disclosure may desirably have a shear modulus (the measure of the resistance to the deformation) of from about 1 kPa (10000 dyne/cm²) to about 600 kPa (6×10⁶ dyne/cm²) at 40° C. (measured on a Rheometric Dynamic Analyzer with dynamic temperature steps, 0-100° C. at 3° C./min; parallel plate; 0.5% strain; 10 rad/s). A preferred gum base according to some embodiments of the present invention may have a shear modulus of from about 5 kPa (50000 dyne/cm²) to about 300 kPa (3×10⁶ dyne/cm²), or even from about 10 kPa (1×10⁵ dyne/cm²) to about 70 kPa (7×10⁵ dyne/cm²).

A variety chewing gum formulations including the gum bases described herein can be created and/or manufactured in accordance with the present invention. Because of the low polarity of the bases described herein, a gum cud formed from the chewing gum is more easily removed from concrete and cement surfaces onto which it may become adhered than gum cuds formed from commercially available chewing gums containing conventional gum bases.

The gum base described herein may constitute from about 0.1 wt % to about 98 wt % by weight of the chewing gum. More typically, the inventive gum base may constitute from about 10 wt % to about 50 wt % of the chewing gum and, in various preferred embodiments, may constitute from about 20 wt % to about 35% by weight of the chewing gum.

Any of the removability enhancing components discussed herein may also be added to the chewing gum, either instead of, or in addition to, any amount thereof added to the gum base. For example, a polymer containing hydrolysable units or an ester or ether of such a polymer may be added to the chewing gum at levels of from about 1 wt % to about 7 wt % based upon the total weight of the chewing gum. As with other insoluble gum base components, they should be included in the gum base polarity calculations regardless of where they are added.

Further, in some embodiments, high levels of emulsifiers such as powdered lecithin may be incorporated into the chewing gum at levels of 3 to 7% by weight of the chewing gum in order to enhance the removability of gum cuds produced therefrom. In such embodiments, it may be advantageous to spray dry or otherwise encapsulate the emulsifier to delay its release.

Any combination of any number of the described approaches may be employed simultaneously to achieve improved removability. Further, and as described above, the described removability enhancing components, or any other components known to those of ordinary skill in the art to be useful for this purpose, may be incorporated into the gum base and/or chewing gum.

In addition to the gum base, chewing gum typically includes a bulk portion which may include bulking agents, high intensity sweeteners, one or more flavoring agents, water-soluble softeners, binders, colorants, acidulants, antioxidants, and other components that provide attributes desired by consumers of chewing gum. Any or all of these may be included in the present chewing gums.

In some embodiments, one or more bulking agent(s) or bulk sweetener(s) may be provided in chewing gums described herein to provide sweetness, bulk and texture to the chewing gum. Bulking agents may also be selected to allow marketing claims to be used in association with the chewing gums. That is, if it is desirable to promote a chewing gum as low calorie, low calorie bulking agents such as polydextrose may be used, or, if the chewing gum is desirably promoted as comprising natural ingredients, natural bulking agents such as isomaltulose, inulin, agave syrup or powder, erythritol, starches and some dextrins may be used. Combinations of any of the above bulking agents may also be used in the present invention.

Typical bulking agents include sugars, sugar alcohols, and combinations thereof. Sugar bulking agents generally include saccharide-containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol and combinations thereof are substituted for sugar bulking agents.

Bulking agents typically constitute from about 5 wt % to about 95 wt % of the total weight of the chewing gum, more typically from about 20 wt % to about 80 wt % and, still more typically, from about 30 wt % to about 70 wt % of the total weight of the chewing gum.

If desired, it is possible to reduce or eliminate the bulking agent to provide a reduced calorie or calorie-free chewing gum. In such embodiments, the gum base may constitute up to about 98 wt % of the chewing gum. Or, a low caloric bulking agent can be used. Examples of low caloric bulking agents include, but are not limited to, polydextrose; Raftilose; Raftilin; fructooligosaccharides (NutraFlora®); Palatinose oligosaccharide; Guar Gum Hydrolysate (Sun Fiber®); or indigestible dextrin (Fibersol®). The caloric content of a chewing gum can also be reduced by increasing the relative level of gum base while reducing the level of caloric sweeteners in the product. This can be done with or without an accompanying decrease in piece weight.

For example, in these and other embodiments, high intensity artificial sweeteners can be used alone or in combination with the bulk sweeteners. Preferred sweeteners include, but are not limited to sucralose, aspartame, salts of acesulfame, alitame, neotame, saccharin and its salts, cyclamic acid and its salts, glycyrrhizin, stevia and stevia derivatives such as Rebaudioside A, dihydrochalcones, lo han guo, thaumatin, monellin, etc., or combinations of these. In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Generally speaking, appropriate levels of artificial sweeteners thus may vary from about 0.02 wt % to about 8 wt %. When carriers used for encapsulation are included, the usage level of the encapsulated sweetener will be proportionately higher.

A variety of natural or artificial flavoring agents, and may be used in any number or combination, if desired. Flavoring agents may include essential oils, natural extracts, synthetic flavors or mixtures thereof including, but not limited to, oils derived from plants and fruits such as citrus oils, fruit essences, peppermint oil, spearmint oil, other mint oils, clove oil, oil of wintergreen, anise and the like.

Artificial flavoring agents and components may also be used. Sensate components which impart a perceived tingling or thermal response while chewing, such as a cooling or heating effect, also may be included. Such components include cyclic and acyclic carboxamides, menthol and menthol derivatives such as menthyl esters of food acceptable acids, and capsaicin among others. Acidulants may be included to impart tartness.

The desired flavoring agent(s) can be used in amounts of from approximately 0.1 wt % to about 15 wt % of the gum, and preferably, from about 0.2 wt % to about 5 wt %.

Water-soluble softeners, which may also be known as water-soluble plasticizers, plasticizing agents, binders or binding agents, generally constitute between approximately 0.5 wt % to about 15 wt % of the chewing gum. Water-soluble softeners may include glycerin, propylene glycol, and combinations thereof.

Syrups or high-solids solutions of .sugars and/or sugar alcohols such as sorbitol solutions, hydrogenated starch hydrolysates (HSH), corn syrup and combinations thereof, may also be used. In the case of sugar gums, corn syrups and other dextrose syrups (which contain dextrose and significant amounts higher saccharides) are most commonly employed. These include syrups of various DE levels including high-maltose syrups and high fructose syrups. In some cases, low-moisture syrups can replace some or all of the bulking agents typically use, in which case usage levels of the syrup may extend up to 50 wt. % or more of the total gum composition. In the case of sugarless products, solutions of sugar alcohols including sorbitol solutions and hydrogenated starch hydrolysate syrups are commonly used.

Also useful are syrups such as those disclosed in U.S. Pat. No. 5,651,936 and US 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed.

In some embodiments, an active agent such as a drug, a dental health ingredients or dietary supplement can be used in combination with the gums and gum bases of the present invention. In such cases, the active agent may be incorporated into the gum base, the chewing gum or into associated non-gum portions of a finished product such as into a coating or a candy layer. In some cases, the active may be encapsulated to control its release or to protect it from other product ingredients or environmental factors.

The chewing gum formulations provided herein may also contain one or more other ingredients conventional in the art, such as gum emulsifiers, colorants, acidulants, fillers, antioxidants and the like. Such ingredients may be used in the present chewing gum formulations in amounts and in accordance with procedures well known in the art of chewing gum manufacture.

Chewing gum is generally manufactured by sequentially adding the various chewing gum ingredients, including the gum base, to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

In some embodiments, the chewing gum may be prepared according to a batch process. In such a process, the ingredients are mixed by first melting the gum base and adding it to the running mixer. The gum base may alternatively be melted in the mixer. Color and emulsifiers may be added at this time.

A chewing gum softener such as glycerin can be added next along with a portion of the bulking agent. Further portions of the bulking agent may then be added to the mixer. Flavoring agents are typically added with the final portion of the bulking agent. The entire mixing process typically takes from about five to about fifteen minutes, although longer mixing times are sometimes required.

In other embodiments, it may be possible to prepare the gum base and chewing gum in a single high-efficiency extruder as disclosed in U.S. Pat. No. 5,543,160. Chewing gums of the present invention may be prepared by a continuous process including the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer. In yet another alternative, a finished gum base may be metered into a continuous extruder along with other gum ingredients to continuously produce a chewing gum composition.

The resultant chewing gums may be formed into sticks, tabs, chunks, tapes, coated or uncoated pellets or balls or any other desired form. In some embodiments, the chewing gum formulation may be used as a component of a greater confectionery product, for example as a center in a hard candy such as a lollipop or as one or more layers of a layered confection which also includes non-gum confectionery layers.

In still other embodiments, the premixed gum base and other gum ingredients may be provided in powder or granulate forms to be dry blended and compressed into a final product form using a tablet press or other means. In a variation, a chewing gum formula may be mixed conventionally using the above batch or continuous processes and then ground into a powder which is optionally dry blended with other ingredients before being compressed.

Of course, many variations on the basic gum base and chewing gum mixing processes are possible.

### EXAMPLES

The following examples of the invention and comparative formulations illustrate certain aspects and embodiments of the present invention, but do not limit the invention described and claimed. Amounts listed are in weight percent, based upon the total weight of the gum base, or chewing gum, as the case may be.

### Example 1

An inventive gum base was prepared according to the formula in Table 3.

### Comparative Run 2

A conventionally formulated comparative gum base known to have high adhesion to concrete was prepared according to the formula in Table 3 to act as a high adhesion control.

### Comparative Run 3

A comparative gum base known to have low adhesion to concrete was prepared according to the formula in Table 3 to act as a reduced adhesion control.

TABLE 3

| | | | | Comparative Run | | Comparative | |
|---|---|---|---|---|---|---|---|
| | | Example 1— | | 2—High | | Run 3—Reduced | |
| | | Inventive | | Adhesion Control | | Adhesion Control | |
| | | | Polarity | | Polarity | | Polarity |
| | Polarity | | Contri- | | Contri- | | Contri- |
| | Index | | bution | | bution | | bution |
| Ingredient | (MPa^{1/2}) | (wt. %) | (MPa^{1/2}) | (wt. %) | (MPa^{1/2)} | (wt. %) | (MPa^{1/2)} |
| Butyl Rubber | 0 | 10.54 | 0.00 | 6.16 | 0.00 | 10.32 | 0.00 |
| Polyisobutylene | 0 | 8.97 | 0.00 | 1.14 | 0.00− | — | — |
| Microcrystalline | 0 | 78.92 | 0.00 | — | — | — | — |
| Wax | | | | | | | |
| Calcium | 6.50 | — | — | 42.62 | 2.77 | — | — |
| Carbonate | | | | | | | |
| Talc | 3.58 | 0.22 | 0.01 | 1.42 | 0.05 | 4.04 | 0.14 |
| Polyvinyl Acetate | 5.94 | — | — | 16.99 | 1.01 | 23.40 | 1.39 |
| Partially and Fully | 1.05 | — | — | 9.61 | 0.10 | 23.94 | 0.25 |
| Hydrogenated | | | | | | | |
| Vegetable Oils | | | | | | | |
| Lecithin | 3.07 | 1.35¹ | 0.04 | 3.26¹ | 0.10 | 1.35¹ | 0.04 |
| Terpene Resin | 0.51 | — | — | 15.80 | 0.08 | 31.37 | 0.16 |
| Mono-and Di- | 2.19 | — | — | 2.96 | 0.06 | 5.53 | 0.12 |
| glycerides | | | | | | | |
| Antioxidant | | | | 0.04 | 0.00 | 0.05 | 0.00 |
| Total | NA. | 100.00 | 0.05 | 100.00 | 4.17 | 100.00 | 2.10 |

¹Part or all of the lecithin was actually added to the gum mixer (Ex. 4-6) but here is included in the gum base composition for ease of calculating the overall Polarity Index...
²Part of the calcium carbonate was actually added to the gum mixer (Ex. 5) but here is included in the gum base composition for ease of calculating the overall Polarity Index.

### Example 4

An inventive chewing gum was prepared according to the formula in Table 4.

### Comparative Run 5

An adhesive chewing gum was prepared according to the formula in Table 4.

### Comparative Run 6

A reduced adhesion chewing gum was prepared according to the formula in Table 4.

TABLE 4

| | | Comparative Run | Comparative Run |
|---|---|---|---|
| | Example | 5—Adhesive | 6—Reduced |
| | 4—Inventive | Control | Adhesion Control |
| Sorbitol | 59.89 | 46.43 | 58.60 |
| Gum base of Ex. 1 | 33.45 | — | — |
| Gum base of Ex. 2 | — | 46.45 | — |
| Gum base of Ex. 3 | — | — | 34.13 |
| Glycerin | 4.00 | 4.00 | 4.08 |
| Peppermint Flavor | 1.84 | 2.30 | 2.35 |
| High Intensity | 0.82 | 0.82 | 0.84 |
| Sweetener | | | |
| Total | 100.00 | 100.00 | 100.00 |

The chewing gums of Example/Comparative Runs 4, 5 and 6 were formed into pellets and pan coated with maltitol to a coating level of approximately 30.5% by weight of the finished pellet. The weight of the coated pellets was approximately 1.4 grams each.

The coated chewing gums of Example/Comparative Runs 4, 5 and 6 were tested for removability in four geographic locations. Multiple locations were used to provide a variety of autumn weather conditions. In each location, the chewing gums were tested as follows.

Cud preparation: Two coated pellets (approximately 2.8 grams) were chewed for twenty minutes.

Gum cud placement on paver: A coarse texture concrete paver was rinsed with tap water and air dried overnight. The paver was set on flat ground with the flat surface face up. A freshly chewed gum cud was placed in the center of the paver. The cud was immediately covered by a silicone pad. A person weighing 150-200 lbs (68 to 91 kg.) wearing flat-sole shoes stepped on the covered cud for 2 seconds. The silicone pad was then immediately removed.

Gum cud ageing: 14 days at prevailing outdoor conditions.

Removability Testing: A power washer using cold tap water at 1550 PSI was used to wash the cuds from the concrete. The nozzle angle was set at 60 degrees from the ground, and the spray pattern was set to a fan shape covering 3 cm width on ground when the nozzle was held 40 cm from the cud. The cud was washed for up to 1 minute. A photo was taken before and after the removal test, using a one cent coin as a reference mark for photographic analysis. The percentage of residue remaining after pressure washing was estimated from the after photo. If the cud was completely removed during power wash, the removal time was recorded.

The results of the removability test are summarized below in Table 5. The intervals, where provided, represent one standard deviation (N=3).

TABLE 5

| | | Location | | | |
|---|---|---|---|---|---|
| | | Northeast | Southwest | Midwest | Southwest |
| | | UK | UK | US | US |
| Ave. Temp (° C.) | | 15.7 | 15.6 | 24.4 | 28.3 |
| Ave. Humidity (% RH) | | 74 | 59 | 75 | 18 |
| Ex. 4 | Removal | 16 +/− 6 | 26 +/−16 | 22 +/− 12 | 29 +/− 18 |
| Inventive | time (s) | | | | |
| | Residue | 0 | 0 | 0 | 0 |
| | (%) | | | | |
| Ex. 5 | Removal | 60 | 60 | 60 | 60 |
| Adhesive | time (s) | | | | |
| | Residue | 63 +/− 10 | 65 +/− 23 | 85 +/− 26 | 98 +/− 2 |
| | (%) | | | | |
| Ex. 6 | Removal | 26 +/− 11 | 31 +/− 7 | 60 | 60 |
| Reduced | time (s) | | | | |
| Adhesion | Residue | 0 | 0 | 81 +/− 26 | 93 +/− 13 |
| | (%) | | | | |

As can be seen from the results, higher temperature and lower humidity increased adhesion of all samples. However, in each case the inventive, low polarity sample was more removable than the prior art reduced adhesion control which in turn was more removable than the adhesive control. In fact, the inventive composition was the only one which was 100% removable under all tested conditions.

The chewing gums of Example 4 (inventive) and Comparative Run 5 (adhesive conventional formula) were compared in a consumer test. The gum of Comparative Run 5 was generally preferred, although the gum of Example 4 was well liked. The most significant deficiency of Example 4 was that it was too soft for some panelists. It is believed that this deficiency can be corrected through optimization of the formula within the scope of the claimed inventions.

### Comparative Run 7 and Example 8

To determine the effect of gum base polarity on removal, a series of gum products were made using blends of two bases shown in Table 6.

TABLE 6

| | | Comparative Run 7 | | Example 8 | |
|---|---|---|---|---|---|
| | | Polar Base | | Non-Polar Base | |
| | Polarity | | Polarity | | Polarity |
| | Index | | contribution | | contribution |
| Ingredient | (MPa^{1/2}) | Wt. % | (MPa^{1/2}) | Wt. % | (MPa^{1/2}) |
| Butyl Rubber | 0.0 | 8.67 | 0.00 | 10.69 | 0.00 |
| Polyisobutylene | 0.0 | 1.60 | 0.00 | 9.09 | 0.00 |
| Polyvinyl Acetate | 5.94 | 23.91 | 1.42 | — | — |
| Terpene Resin | 0.51 | 22.24 | 0.11 | — | — |
| Partially and Fully | 1.05 | 13.53 | 0.14 | — | — |
| Hydrogenated | | | | | |
| Vegetable Oil | | | | | |
| Microcrystalline Wax | 0.0 | — | — | 80.00 | 0.00 |
| Mono- and Di- | 2.19 | 4.16 | 0.09 | — | — |
| Glycerides | | | | | |
| Lecithin | 3.07 | 3.23 | 0.10 | — | — |
| Calcium Carbonate | 6.50 | 20.60 | 1.34 | — | — |
| Talc | 3.58 | 2.00 | 0.07 | 0.22 | 0.01 |
| Antioxidant | 0.0 | 0.06 | 0.00 | — | — |
| Total | — | 100.00 | 3.27 | 100.00 | 0.01 |

### Examples/Comparative Runs 9-15

The two bases (Comparative Run 7 and Example 8) were combined in various ratios to make the chewing gums according to Table 7. An overall polarity for each gum was calculated by multiplying the portion of each gum base used times its Polarity Index and adding the Polarity Index for the 0.45 wt. % lecithin which was added directly to the gum mixer. For example, the gum of Example 11 contained 26.40% of Gum Base Example 8, 6.60% of Gum Base Comparative Run 7 and 0.4% lecithin for a total base content of 33.45% so its overall polarity was (26.40*0.01+6.60*3.27+0.45*3.07)/33.45 =0.69 MPa¹¹² (rounded). In this way, a series of chewing gums with a range of polarities were created for testing.

TABLE 7

| Ex./ CR #: | Ex. 9 | Ex. 10 | Ex. 11 | Ex. 12 | Ex. 13 | CR 14 | CR 15 |
|---|---|---|---|---|---|---|---|
| Overall Polarity | 0.05 | 0.37 | 0.69 | 1.34 | 1.98 | 2.62 | 3.27 |
| (MPa^{1/2}) | | | | | | | |
| Gum Base of Ex. 8 | 33.00 | 29.70 | 26.40 | 19.80 | 13.20 | 6.60 | — |
| (Polarity = 0.01) | | | | | | | |
| Gum Base of CR. 7 | — | 3.30 | 6.60 | 13.20 | 19.80 | 26.40 | 33.00 |
| (Polarity = 3.27) | | | | | | | |
| Lecithin | 0.45 | 0.45 | 0.45 | 0.45 | 0.45 | 0.45 | 0.45 |
| Sorbitol | 59.89 | 59.89 | 59.89 | 59.89 | 59.89 | 59.89 | 59.89 |
| Glycerin | 4.00 | 4.00 | 4.00 | 4.00 | 4.00 | 4.00 | 4.00 |
| Peppermint | 1.84 | 1.84 | 1.84 | 1.84 | 1.84 | 1.84 | 1.84 |
| Flavor | | | | | | | |
| High Intensity | 0.82 | 0.82 | 0.82 | 0.82 | 0.82 | 0.82 | 0.82 |
| Sweeteners | | | | | | | |
| (Encapsulated) | | | | | | | |
| Total | 100.00 | 100.00 | 100.00 | 100.00 | 100.00 | 100.00 | 100.00 |

The products of Examples/Comparative Runs 9-15 were formed into pellets and coated as before.

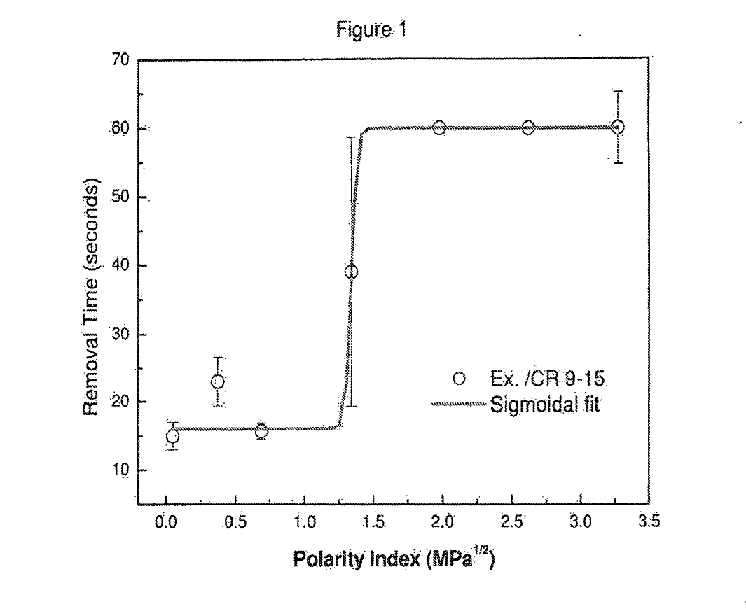

The seven coated chewing gums (Examples/Comparative Runs 9-15) were tested for removability as before except that they were aged for 2 days at 45° C./10%. Three samples of each gum were tested. The average removal times with one standard deviation are shown in FIG. 1. As can be seen, a dramatic increase in removal times is seen at higher polarity levels starting at about 1.30 MPa^{½}. Note also the large standard deviation associated with Example 12 which was near the transition point. This demonstrates a significant reduction in adhesion when the polarity of the gum base is maintained below about 1.50 MPa^{½}.

### Comparative Run 16

An additional gum base was prepared according to Table 8.

TABLE 8

Comparative Run 16
Polar Base

| | Polarity | | Polarity |
|---|---|---|---|
| | Index | | contribution |
| Ingredient | (MPa^{1/2}) | Wt. % | (MPa^{1/2}) |
| Butyl Rubber | 0.0 | 10.46 | 0.00 |
| Polyvinyl Acetate | 5.94 | 23.72 | 1.40 |
| Terpene Resin | 0.51 | 31.81 | 0.16 |
| Fully and Partially | 1.05 | 24.26 | 0.25 |
| Hydrogenated | | | |
| Vegetable Oil | | | |
| Mono- and Di- | 2.19 | 5.61 | 0.12 |
| Glycerides | | | |
| Talc | 3.58 | 4.09 | 0.15 |
| Antioxidant | 0.0 | 0.05 | 0.00 |
| Total | — | 100.00 | 2.08 |

### Examples/Comparative Run 17-23

Seven additional chewing gums were made according to the formulas in Table 9. The overall Polarity Index was calculated as in Examples/Comparative Run 9-15.

TABLE 9

| Ex./CR # | Ex. 17 | Ex. 18 | Ex. 19 | Ex. 20 | Ex. 21 | Ex. 22 | CR 23 |
|---|---|---|---|---|---|---|---|
| Overall Polarity | 0.04 | 0.24 | 0.45 | 0.85 | 1.26 | 1.67 | 2.08 |
| (MPa^{1/2}) | | | | | | | |
| Gum Base of Ex. 8 | 33.67 | 30.30 | 26.94 | 20.20 | 13.47 | 6.73 | — |
| (Polarity = 0.01) | | | | | | | |
| Gum Base of CR 16 | — | 3.37 | 6.73 | 13.47 | 20.20 | 26.94 | 33.67 |
| (Polarity = 2.08) | | | | | | | |
| Lecithin | 0.46 | 0.46 | 0.46 | 0.46 | 0.46 | 0.46 | 0.46 |
| Sorbitol | 58.60 | 58.60 | 58.60 | 58.60 | 58.60 | 58.60 | 58.60 |
| Glycerin | 4.08 | 4.08 | 4.08 | 4.08 | 4.08 | 4.08 | 4.08 |
| Peppermint | 2.35 | 2.35 | 2.35 | 2.35 | 2.35 | 2.35 | 2.35 |
| Flavor | | | | | | | |
| High Intensity | 0.84 | 0.84 | 0.84 | 0.84 | 0.84 | 0.84 | 0.84 |
| Sweeteners | | | | | | | |
| (Free and | | | | | | | |
| Encapsulated) | | | | | | | |
| Total | 100.00 | 100.00 | 100.00 | 100.00 | 100.00 | 100.00 | 100.00 |

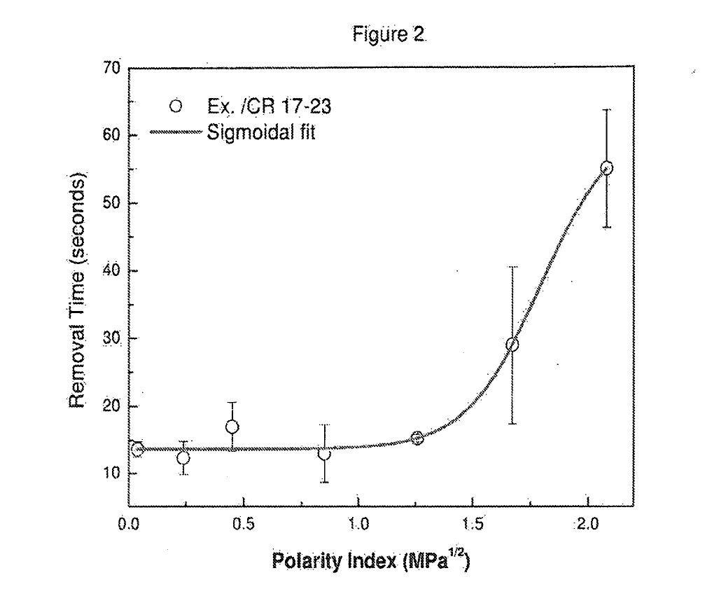

The gums were coated as before and tested in the same manner as Examples/Comparative Runs 9-15 except that the samples were aged for 5 days at 50° C./10% RH. The results are shown in FIG. 2. As can be seen, adhesion of the cud is significantly reduced when the gum base is formulated to have a polarity below about 2.00 MPa^{½}.

### Examples/Comparative Runs 24-30

Seven additional chewing gums were made according to the formulas in Table 10. The overall Polarity Index was calculated as in Examples/Comparative Runs 9-15.

TABLE 10

| Ex./CR # | Ex. 24 | Ex. 25 | Ex. 26 | Ex. 27 | Ex. 28 | CR 29 | CR 30 |
|---|---|---|---|---|---|---|---|
| Overall Polarity | 0.04 | 0.36 | 0.68 | 1.32 | 1.96 | 2.61 | 3.25 |
| (MPa^{1/2}) | | | | | | | |
| Gum Base of Ex. 8 | 33.67 | 30.30 | 26.94 | 20.20 | 13.47 | 6.73 | — |
| (Polarity = 0.01) | | | | | | | |
| Gum Base of CR. 7 | — | 3.37 | 6.73 | 13.47 | 20.20 | 26.94 | 33.67 |
| (Polarity = 3.27) | | | | | | | |
| Lecithin | 0.46 | 0.46 | 0.46 | 0.46 | 0.46 | 0.46 | 0.46 |
| Sorbitol | 58.60 | 58.60 | 58.60 | 58.60 | 58.60 | 58.60 | 58.60 |
| Glycerin | 4.08 | 4.08 | 4.08 | 4.08 | 4.08 | 4.08 | 4.08 |
| Peppermint | 2.35 | 2.35 | 2.35 | 2.35 | 2.35 | 2.35 | 2.35 |
| Flavor | | | | | | | |
| High Intensity | 0.84 | 0.84 | 0.84 | 0.84 | 0.84 | 0.84 | 0.84 |
| Sweeteners | | | | | | | |
| (Free and | | | | | | | |
| Encapsulated) | | | | | | | |
| Total | 100.00 | 100.00 | 100.00 | 100.00 | 100.00 | 100.00 | 100.00 |

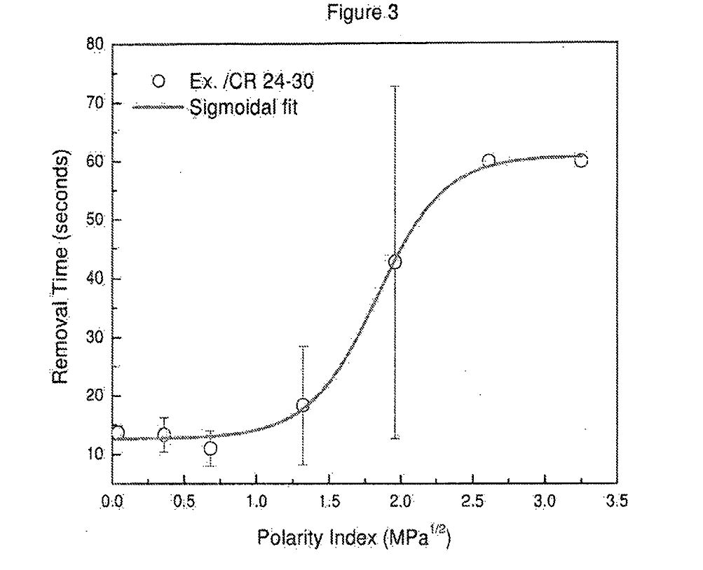

The gums were again coated as before and tested in the same manner as Examples/Comparative Runs 17-23 with the results shown in FIG. 3. As can be seen, adhesion of the cud is significantly reduced when the gum base is formulated to have a polarity below about 2.00 MPa^{½}.

All patents, patent applications, provisional applications, and publications referred to or cited herein are incorporated by reference in their entirety to the extent they are not inconsistent with the explicit teachings of this specification. Further, while only certain features of the invention have been illustrated and described herein, many modifications and changes will occur to those skilled in the art. It is, therefore, to be understood that the appended claims are intended to cover all such modifications and changes as fall within the true spirit of the invention.

1-20. (canceled)

1. A chewing gum base comprising 3 to 30 wt. % elastomer, 0 to 32% elastomer solvent and 0 to 8 wt. % paraffin wax wherein the chewing gum base has a polarity index of less than 2.00 MPa^{½}.

2. The chewing gum base of claim 1, wherein the polarity index is less than 1.90 MPa^{½}.

3. The chewing gum base of claim 1, wherein the polarity index is less than 1.80 MPa^{½}.

4. The chewing gum base of claim 1, wherein the polarity index is less than 1.70 MPa^{½}.

5. The chewing gum base of claim 1, wherein the polarity index is less than 1.60 MPa^{½}.

6. The chewing gum base of claim 1, wherein the gum base comprises 5 to 30 wt. % elastomer.

7. The chewing gum base of claim 2, wherein the gum base comprises 10 to 25 wt. % elastomer.

8. The chewing gum base of claim 1, wherein the gum base comprises 0 to 30 wt. % elastomer solvent.

9. The chewing gum base of claim 2, wherein the gum base comprises 0 to 25 wt. % elastomer solvent.

10. The chewing gum base of claim 1, wherein the gum base comprises 0 to 5 wt. % paraffin wax.

11. The chewing gum base of claim 2, wherein the gum base comprises 0 to 2 wt. % paraffin wax.

12. The chewing gum base of claim 1, wherein the gum base comprises 0 to 30 wt. % polyvinylacetate.

13. The chewing gum base of claim 1, wherein the gum base comprises 0 to 30 wt. % filler.

14. A chewing gum comprising the chewing gum base of claim 1.

15. The chewing gum of claim 14 wherein the chewing gum further comprises an additive which enhances removability of a cud formed by chewing the gum.

16. The chewing gum of claim 15 wherein the additive is selected from the group consisting of an amphiphilic polymer, a polymer having a straight or branched chain carbon-carbon backbone and a multiplicity of side chains attached to the backbone, a polymer having hydrolysable units, an ester and/or ether of a polymer having hydrolysable units, or a combination thereof.

17. A method of making the chewing gum of claim 14 wherein a premixed chewing gum base is introduced into a mixing apparatus; at least one chewing gum ingredient selected from the group consisting of flavors, sweeteners and combinations thereof is added to the mixing apparatus; and the ingredients are mixed to produce a homogeneous chewing gum.

18. The method of claim 17 wherein at least one chewing gum base component separate from the premixed chewing gum base is added to the gum mixer

19. The method of claim 18 wherein the at least one chewing gum base component separate from the premixed chewing gum base is selected from the group consisting of emulsifiers, fillers, softeners and combinations thereof.

20. The method of claim 19 wherein the at least one chewing gum base component added separately to the gum mixer comprises an emulsifier and wherein at least a portion of the emulsifier is spray dried or encapsulated.
